(19) United States
(12) Patent Application Publication
(10) Pub. No.: US 2006/0271632 A1
(43) Pub. Date: Nov. 30, 2006

(54) System and method of voicemail and videomail storage for instant messaging users

(75) Inventor: Jason D. Livingood, Philadelphia, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC

(21) Appl. No.: 11/138,571

(22) Filed: May 26, 2005

(51) Int. Cl. G06F 15/16

(52) U.S. Cl. 709/206

(57) ABSTRACT

A communication method and system for leaving voicemail and videomail messages for an instant messaging user through the use of an instant messaging system having at least one instant messaging client. The method includes configuring the at least one instant messaging client to receive instant messages containing audio and/or video content. Another step includes generating an instant message containing audio and/or video content for the at least one instant messaging client through the use of the instant messaging system. The method also includes receiving the instant message at a message storage and retrieval system, wherein the message storage and retrieval system is adapted to store instant messages having audio and/or video content. The method further includes storing the instant message at the message storage and retrieval system, wherein the at least one instant messaging client is operable with the message storage and retrieval system for retrieval of the stored instant message. The communication system enables an instant messaging user to leave and retrieve voicemail and videomail messages through the use of the instant messaging system.

### BACKGROUND OF THE INVENTION

1. Field of the Invention

The present invention relates generally to instant messaging (IM) systems and more specifically to storing voicemail and/or videomail messages for an instant messaging user.

2. Background Art

Instant messaging systems have experienced substantial usage in facilitating communications over the Internet. One reason for the increased use includes the audio and video functionality of more recent instant messaging systems. With these instant messaging systems an instant messaging user may exchange audio and/or video content through the use of an instant messaging client. Such functionality has given instant messaging systems phone-like characteristics. For example, some instant messaging systems enable an instant messaging user to call other instant messaging users and communicate, in real-time, by speaking into microphones that are operable with their respective instant messaging clients. The same functionality is equally applicable to video messages that are generated by one instant messaging user and sent to a second instant messaging user through the use of cameras that are operable with each user's instant messaging client. Because of the foregoing features of instant messaging systems, some users employ their instant messaging systems for communicating with others in lieu of traditional means of communicating (e.g., telephones). However, although instant messaging systems exhibit these capabilities they also possess several disadvantages.

Despite the increased use of instant messaging systems in lieu of and in addition to traditional means of communicating, instant messaging users are unable to leave voicemail or visual mail (hereinafter referred to as videomail) messages for other instant messaging users. Just as users of traditional telephone systems leave voicemail messages for other users via the telephone system, instant messaging users desire to leave messages (i.e., voicemail and/or videomail) via the instant messaging system for other instant messaging users.

### SUMMARY OF THE INVENTION

The present invention provides a communication method and system for leaving messages for an instant messaging user through the use of an instant messaging system having at least one instant messaging client. The method includes configuring the at least one instant messaging client to receive instant messages containing audio and/or video content. Another step includes generating an instant message containing audio and/or video content for the at least one instant messaging client through the use of the instant messaging system. The method also includes receiving the instant message at a message storage and retrieval system, wherein the message storage and retrieval system is adapted to store instant messages having audio and video content. The method further includes storing the instant message at the message storage and retrieval system, wherein the at least one instant messaging client is operable with the message storage and retrieval system for retrieval of the stored instant message.

The communication system of the present invention enables an instant messaging user to leave and retrieve voicemail and videomail messages through the use of the instant messaging system. The communication system includes a message storage and retrieval system that is operable with the instant messaging system and configured to store instant messages containing audio or video content. At least one instant messaging client is included and is operable with the instant messaging system and the message storage and retrieval system. The at least one instant messaging client is also configured to receive the stored instant messages containing audio or video content. The communication system further includes a user interface being operable with the at least one instant messaging client and configured to display hypertext links to the stored instant messages.

### BRIEF DESCRIPTION OF THE DRAWINGS

These and other features and advantages of the invention will be apparent from the following detailed description and the appended claims, taken in conjunction with the accompanying drawings, in which:

FIG. 1 illustrates a communication system that enables an instant messaging user to leave and retrieve voicemail and/or videomail messages according to an embodiment of the present invention;

FIG. 2 illustrates a flow diagram of a method for leaving and retrieving voicemail and/or videomail messages through the use of the communication system of FIG. 1;

FIG. 3 illustrates an exemplary embodiment of an instant messaging client user interface for viewing and/or retrieval of voicemail and/or videomail through the use of the communication system of FIG. 1; and

FIG. 4 illustrates an exemplary embodiment of a world-wide-web Internet page (also known as a web page or web site) for viewing and/or retrieval of voicemail and/or videomail through the use of the communication system of FIG. 1.

### DETAILED DESCRIPTION OF THE PREFERRED EMBODIMENT(S)

By way of example, a preferred system and methodology for implementing the present invention is described below. The provided system and methodology may be adapted, modified or rearranged to best-fit a particular implementation of the present invention.

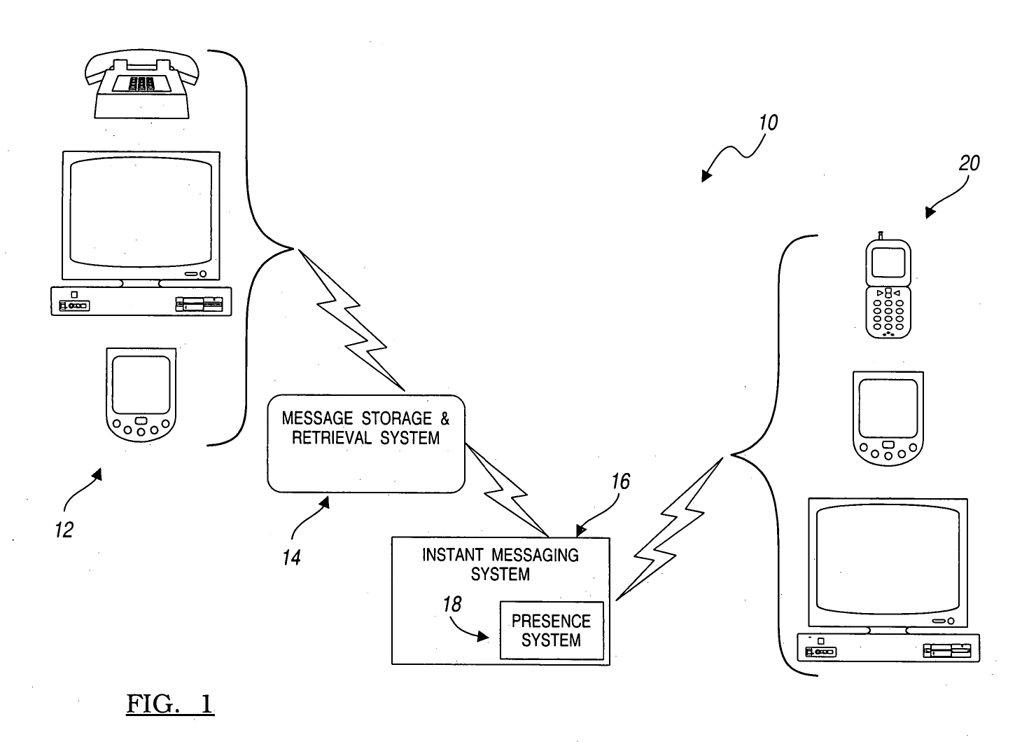

Referring to FIG. 1, a communication system 10 is illustrated. Communication system 10 includes a caller device 12, a message storage and retrieval system 14, an instant messaging system 16, a presence system 18, and an instant messaging user device 20. Communication system 10, which may provide telephony services, enables the transfer of voice, video, and data from caller device 12 to instant messaging user device 20. As such, caller device 12 is capable of initiating and receiving calls and data, and may be a traditional telephone, computer, cellular telephone, or personal digital assistant (PDA).

When a user initiates a call or generates a message on caller device 12 for instant messaging user device 20, message storage and retrieval system 14 is adapted to store any messages or data to be received by instant messaging user device 20. Message storage and retrieval system 14 is capable of storing instant messages that contain audio and/or video content. Thus, message storage and retrieval system 14 is configured to receive and store email, voicemail, and/or videomail messages. Accordingly, in one embodiment, message storage and retrieval system 14 may be a unified messaging system having data storage and data processing functionality. Alternatively, message storage and retrieval system 14 may be comprised of separate and distinct systems that store email, voicemail, and/or videomail messages. In either embodiment, an instant messaging system 16 is communicative with message storage and retrieval system 14. Instant messaging system 16 enables instant messaging user device 20 to send and receive instant messages having audio and video content to/from other instant messaging users. As such, instant messaging system 16 includes an instant messaging client (not shown) that enables communications through the use of instant messaging system 16. The instant messaging client, being configured to transmit and receive instant messages having audio and video content, also provides a user interface that is displayed on instant messaging user device 20.

A presence system 18 is integrated with instant messaging system 16 through the use of a “presence” software that is compatible with instant messaging system 16. Presence system 18 is capable of querying message storage and retrieval system 14 for a mail message status. The mail message status of message storage and retrieval system 14 indicates the presence or absence of a message stored by message storage and retrieval system 14. As recognized by one of ordinary skill in the art, presence system 18 is also capable of determining the “presence status” of the instant messaging client. The presence status of the instant messaging client includes, among other attributes, whether the instant messaging user is online, offline or unavailable. Additionally, in one embodiment, instant messaging system 16, having presence system 18 integrated therein, is capable of generating a message waiting indication in the form of an instant message for the instant messaging client. The generated instant message (i.e., the message waiting indication) is preferably sent upon determination of the mail message status of message storage and retrieval system 14 and presence status of the instant messaging client.

Instant messaging user device 20 is utilized by the instant messaging user to communicate with other instant messaging users through the use of instant messaging system 16. As such, instant messaging user device 20 may be a PDA, a cellular telephone, or a computer configured to receive and/or transmit instant messages having audio or video content. It is recognized however, that instant messaging user device 20 is not limited to the embodiments described herein, but may be any device capable of sending and receiving instant messages through the use of an instant messaging system.

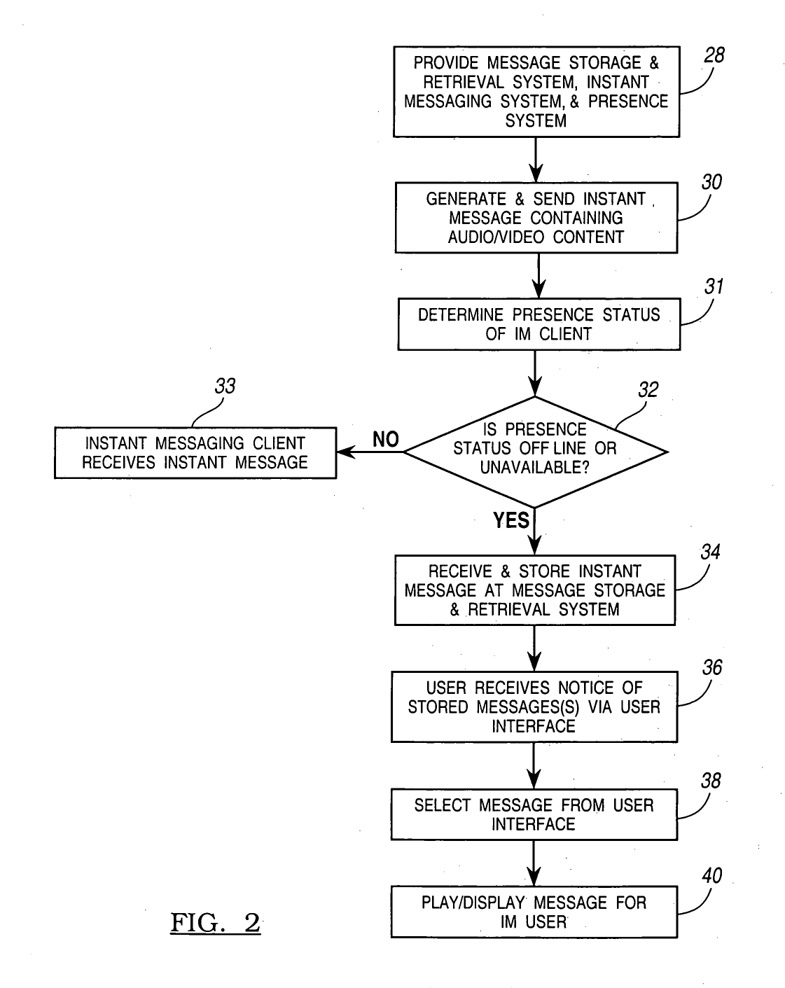

Referring to FIG. 2, a flow diagram of a methodology for leaving a voicemail and/or videomail message for an instant messaging user is illustrated. At a step 28 the message storage and retrieval system, the instant messaging system, and the presence system are provided. At step 28, a first and second instant messaging client being operable with the instant messaging system, are configured to transmit and receive instant messages containing audio or video content. At a step 30, an instant message containing audio and/or video content is generated and sent by the first instant messaging client for the second instant messaging client. At a step 31, the presence status of the first instant messaging client is determined. Specifically, as described above, determining the presence status includes determining whether the instant messaging client indicates an offline, an online, or an unavailable status. Accordingly, at a step 32, the methodology determines whether the present status is offline or unavailable. If the present status is neither offline or unavailable, a step 33 occurs. At step 33, the instant messaging client receives the instant message containing audio/video content. Where the present status is offline or unavailable, a step 34 occurs. At step 34, the message storage and retrieval system receives and stores the instant message containing audio and/or video content. Hereinafter, the stored instant messages containing audio and/or video content are referred to as voice mail and/or videomail respectively. At a step 36, the user receives a notice of the stored voicemail and/or videomail messages through the use of a user interface. The user interface may be an instant message generated by the instant messaging system or an Internet web page. In either case, the interface is operable with the instant messaging system and contains hypertext links to the stored voicemail and videomail messages. At a step 38, through the use of the user interface, the user may select a message for retrieval. Accordingly, at a step 40, the selected message is played or displayed for the instant messaging user.

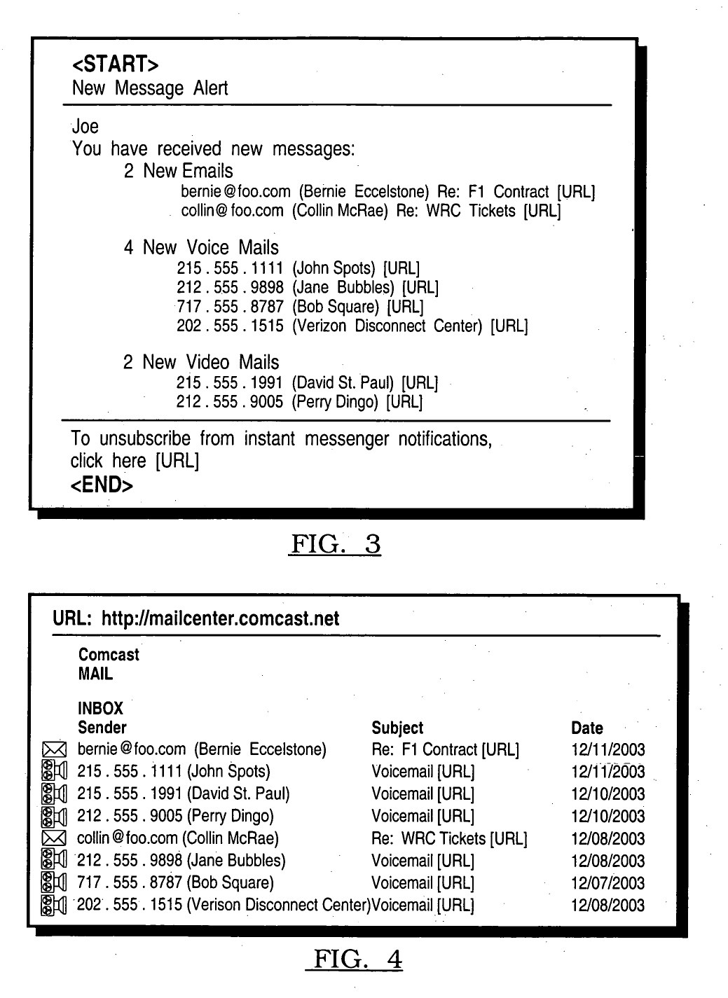

Now referring to FIGS. 3 and 4, embodiments of the user interface are shown that are operable with the instant messaging client and configured to display hypertext links to voicemail and/or videomail messages. In one aspect of the invention, as illustrated by FIG. 3, the user interface is an instant message. In another aspect of the invention, as shown in FIG. 4, the user interface is an Internet web page. In either embodiment, the user interface may include a message header, message count, and detailed message information. As shown, each message may be retrieved by the user through the use of an embedded hypertext-link within the user interface.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for leaving messages for an instant messaging user through the use of an instant messaging system having at least one instant messaging client, comprising:
configuring said at least one instant messaging client to receive instant messages containing audio or video content;
generating an instant message containing audio or video content for said at least one instant messaging client through the use of the instant messaging system;
receiving the instant message at a message storage and retrieval system, wherein said message storage and retrieval system is adapted to store instant messages having audio or video content; and
storing said instant message at said message storage and retrieval system, wherein said at least one instant messaging client is operable with said message storage and retrieval system for retrieval of the stored instant message.

2. A method according to claim 1, further comprising the steps of:
selecting the stored message; and
playing the stored message for the instant messaging user through the use of said at least one instant messaging client.

3. A method according to claim 1, wherein the step of configuring said instant messaging system having at least one instant messaging client includes an instant messaging client having a user interface configured to display hypertext links to said stored instant messages.

4. A method according to claim 1, wherein the step of receiving said instant message at said message storage and retrieval system includes a unified messaging system.

5. A method according to claim 1, further comprising the step of configuring an Internet web page to be operable with said instant messaging system for displaying a hypertext link to said stored message.

6. A communication system for leaving and retrieving voicemail and videomail messages through the use of an instant messaging system comprising:
a message storage and retrieval system operable with the instant messaging system and configured to store instant messages containing audio or video content;
at least one instant messaging client operable with the instant messaging system and the message storage and retrieval system, said at least one instant messaging client being configured to receive the stored instant messages containing audio or video content; and
a user interface operable with the at least one instant messaging client and configured to display hypertext links to the stored instant messages.

7. A system according to claim 6, wherein said message storage and retrieval system is a unified messaging system.

8. A system according to claim 6, wherein said user interface is an Internet web page.

9. A system according to claim 6, wherein the user interface is an instant message.

10. A method for leaving messages for an instant messaging user through the use of an instant messaging system having at least a first and a second instant messaging client comprising the steps of:
configuring said first and said second instant messaging client to transmit and receive instant messages containing audio or video content;
generating an instant message having audio or video content for said second instant messaging client through the use of said first instant messaging client;
receiving said instant message at a message storage and retrieval system, wherein said message storage and retrieval system is adapted to store instant messages having audio and video content;
determining a presence status of said first instant messaging client; and
storing said instant message at said message storage and retrieval system based on said presence status, wherein said second instant messaging client is operable with said message storage and retrieval system for retrieving the stored instant message.

11. A method according to claim 10, further comprising the steps of:
selecting the stored message; and
playing or displaying the stored message for the instant messaging user through the use of said instant messaging client.

12. A method according to claim 10, wherein the step of determining a presence status includes determining if the instant messaging client indicates an offline, an online, or an unavailable status.

13. A method according to claim 10, wherein the step of receiving said instant message at said message storage and retrieval system includes a unified messaging system.

14. A method according to claim 10, wherein the step of determining said presence status occurs through the use of a presence system integrated with the instant messaging system.

15. A method according to claim 10, further comprising the step of configuring an Internet web page to be operable with said instant messaging system for displaying a hypertext link to said stored message.
